(19) United States
(12) Patent Application Publication
(10) Pub. No.: US 2023/0241607 A1
(43) Pub. Date: Aug. 3, 2023

(54) FLEXIBLE MATERIAL FOR USE IN MICROFLUIDIC OR MICROSCALE DEVICES FOR CELL OR PARTICLE MANIPULATION

(71) Applicant: Cyto Recovery, Inc., Blacksburg, VA (US)

(72) Inventors: Alexandra Rochelle HYLER, Christiansburg, VA (US); Katherine Emily Degen, Roanoke, VA (US); Dean Edward Thomas, Blacksburg, VA (US); Hajar Chokhmane, Blacksburg, VA (US); Ridi Barua, Blacksburg, VA (US); Rafael Vidal Davalos, Aptos, CA (US)

(21) Appl. No.: 18/101,259

(22) Filed: Jan. 25, 2023

Related U.S. Application Data
(60) Provisional application No. 63/304,330, filed on Jan. 28, 2022.

(51) Int. Cl. B01L 3/00

(52) U.S. Cl. CPC B01L 3/502715; B01L 3/502738; B01L 3/502707; B01L 2200/025; B01L 2300/0816; B01L 2300/123

(57) ABSTRACT

Disclosed herein are microfluidic devices and methods of making microfluidic devices formed with low melting point metallic electrodes. Disclosed methods include adding a melted electrode material to an electrode channel of a microfluidic device and cooling the melted electrode to form an electrode.

### CROSS-REFERENCE TO RELATED APPLICATION

This application claims priority to U.S. Provisional Patent Application Ser. No. 63/304,330, filed on Jan. 28, 2022, which is hereby incorporated by reference in its entirety.

### FIELD OF THE INVENTION

The present invention relates to devices and methods for dielectrophoresis (DEP) for manipulation of cells or particles, and more specifically, contactless DEP (cDEP) in which electrodes are not in direct contact with the subject sample. The devices and methods of the present invention provide for improved applications and methods of cDEP.

### BACKGROUND OF THE INVENTION

Isolation and enrichment of cells/micro-particles from a biological sample is one of the first crucial processes in many biomedical and homeland security applications. Water quality analysis to detect viable pathogenic bacterium and the isolation of rare circulating tumor cells (CTCs) for early cancer detection are important examples of the applications of this process. Conventional methods of cell concentration and separation include centrifugation, filtration, fluorescence activated cell sorting, or optical tweezers. Each of those techniques relies on different cell properties for separation and has intrinsic advantages and disadvantages. For instance, many of the known techniques require the labeling or tagging of cells in order to obtain separation. Those more sensitive techniques may require prior knowledge of cell-specific markers and antibodies to prepare target cells for analysis.

Dielectrophoresis DEP is the motion of a particle in a suspending medium due to the presence of a non-uniform electric field. DEP utilizes the electrical properties of the cell/particle for separation and identification. The physical and electrical properties of the cell, the conductivity and permittivity of the media, as well as the gradient of the electric field and its applied frequency and voltage are substantial parameters determining a cell's DEP response.

The application of dielectrophoresis to separate target cells from a solution has been studied extensively in the last two decades. Examples of the successful use of dielectrophoresis include the separation of human leukemia cells from red blood cells in an isotonic solution, entrapment of human breast cancer cells from blood, and separation of U937 human monocytic from peripheral blood mononuclear cells (PBMC). DEP has also been used to separate neuroblastoma cells from HTB glioma cells, isolate cervical carcinoma cells, isolate K562 human CML cells, separate live yeast cells from dead, and segregate different human tumor cells. Unfortunately, the microelectrode-based devices used in those experiments are susceptible to electrode fouling and require complicated fabrication procedures.

Insulator-based dielectrophoresis (iDEP) has also been employed to concentrate and separate live and dead bacteria for water analysis. In that method, electrodes inserted into a microfluidic channel create an electric field which is distorted by the presence of insulating structures. The devices can be manufactured using simple fabrication techniques and can be mass-produced inexpensively through injection molding or hot embossing. iDEP provides an excellent solution to the complex fabrication required by traditional DEP devices however, it is difficult to utilize for biological fluids which are highly conductive. The challenges that arise include joule heating and bubble formation. In order to mitigate those effects, oftentimes the electrodes are placed in large reservoirs at the channel inlet and outlet. Without an additional channel for the concentrated sample to pass through, that could re-dilute the sample after it has passed through a concentration region.

While many have had success designing and fabricating different DEP and iDEP microdevices to manipulate particles in biological fluids, there are some potential drawbacks of those techniques. The traditional DEP technique suffers from fouling, contamination, bubble formation near integrated electrodes, low throughput, and an expensive and complicated fabrication process. The insulating obstacles employed by iDEP are meant to address those shortcomings and are less susceptible to fouling than integrated electrodes. The iDEP fabrication process is also much less complicated; the insulating obstacles can be patterned while etching the microchannel in one step. That technique has the added benefit of making the process more economical in that mass fabrication can be facilitated through the use of injection molding. Unfortunately, one of the primary drawbacks of an iDEP system is the presence of a high electric field intensity within the highly conductive biological fluid inside the microchannel. The relatively high electrical current flow in that situation causes joule heating and a dramatic temperature increase.

Rather than carrying out dielectrophoretic manipulation of sensitive biological cells at field termination points on electrodes, an alternate strategy is based on cDEP in which electrodes are not in direct contact with the subject sample. Examples of cDEP that traps or deflects cells due to field bending at non-uniformities that are created, for example, by patterned insulating post structures are described in U.S. Pat. No. 8,968,542, issued on Mar. 3, 2015 and related U.S. Pat. No. 10,078,066, issued on Sep. 18, 2018, each of which are incorporated by reference in their entirety and are referred to collectively as the “Davalos patents.” By physically separating electrode stimulation and sample transport regions, sensitive cells are protected from electrode fouling, while the thin interceding barrier enables field penetration above cut-off frequencies and voltages. Other background microfluidic devices and related methods are described in US publications 2021/0016280; 2016/0243546; 2021/0053815; 2017/0218424, and U.S. Pat. No. 9,267,918, each of which are incorporated by reference in their entirety. FIG. 1 is an example of a DEP device 111 from the Davalos patents. The DEP device 111 is formed in a substrate 119 and includes a sample channel 117 for placing the cells to be separated. Electrodes (not shown) are placed into electrode receiving portions 114,116 and electrically connected with a conductive, electrode fluid that is added to electrode channels 113, 115. An electric signal is generated externally and communicated to the electrode fluid in each of the electrode channels 113, 115 which establishes the electric field across the sample channel 117.

### SUMMARY OF THE INVENTION

Disclosed herein are microfluidic devices. In one aspect of the disclosure, microfluidic device includes at least one electrode channel, an electrode within the electrode channel, where the electrode is metallic and has a melting point below about 70° C. In another aspect of the disclosure, at least one electrode channel comprises at least one electrode contact region and the electrode is within the electrode contact region. In another aspect of the disclosure, at least one electrode channel and the sample channel are formed in a same layer of the of the microfluidic device. In another aspect of the disclosure at least one electrode channel and the sample channel are formed in different layers of the of the microfluidic device. In another aspect of the disclosure, at least one electrode channel comprises at least two electrode contact regions and the electrode channel is exposed to the atmosphere between the at least two electrode contact regions. In yet another aspect of the disclosure the electrode channel includes at least one of a bend, a notch, a saw tooth, and a curve.

Disclosed herein are microfluidic devices where the electrode is at least one of a eutectic metal alloy, a bismuth metal alloy, Fields metal, Field's allow, Cerrolow 136, Cerrolow 117, a Bi—Pb—Sn—Cd—In—Tl alloy, and Wood's metal. In another aspect of the disclosure, an electrode has a melting point between about 41.5° C. to about 70° C. In another aspect of the disclosure a sample channel is fluidically isolated from the one or more electrode channel.

Disclosed herein are methods of making microfluidic devices. In one aspect of the disclosure, the method includes providing a metallic electrode material and heating the electrode material at least to its melting point to form a melted electrode material, adding the melted electrode material to an electrode channel of a microfluidic device, and cooling the melted electrode material to form an electrode. In another aspect of the disclosure, adding the melted electrode material to the electrode channel includes injecting the melted electrode material. In another aspect of the disclosure adding the melted electrode material to the electrode channel comprises injecting the melted electrode material with about steady pressure. In another aspect of the disclosure, injecting the melted electrode comprises injecting the melted electrode with at least one of a syringe and a pump. In another aspect of the disclosure, steady pressure is between about 0.06 to about 1 pounds per square inch (psi). In another aspect of the disclosure, warming at least one of a syringe and a pump above ambient temperature. In another aspect of the disclosure, disclosed methods include piercing a top layer. In another aspect of the disclosure, adding the melted electrode material to the electrode channel comprises filing the electrode channel between a plurality of electrode contact regions. In another aspect of the disclosure, the methods include warming the microfluidic device above ambient temperature. In another aspect of the disclosure, the methods include cooling the melted electrode material sufficiently to form a solid electrode.

### BRIEF DESCRIPTION OF THE FIGURES

FIG. 1 shows a perspective view of a prior art microfluidic device;

FIG. 2 shows a perspective view of a disclosed microfluidic device in accordance with disclosed embodiments;

FIG. 3 shows a perspective view of a disclosed microfluidic device in accordance with disclosed embodiments; and

FIG. 4 shows a method of making disclosed microfluidic devices in accordance with disclosed embodiments.

### DETAILED DESCRIPTION OF THE INVENTION

Considering the state of the prior art, described herein are microfluidic devices having improved electrodes, and methods of forming the same, that are useful in cDEP and other microfluidic applications.

Non-limiting examples of microfluidic device designs are presented herein. Some examples are illustrated in the figures, where like numbering may be used to refer to like elements in different figures. The objects and elements shown in a single figure may or may not all be present in one device. The present invention contemplates any microfluidic device engineered so that there is no direct physical contact between the electrodes and the sample solution, and there will be modifications of the examples set forth herein that will be apparent to one of skill in the art.

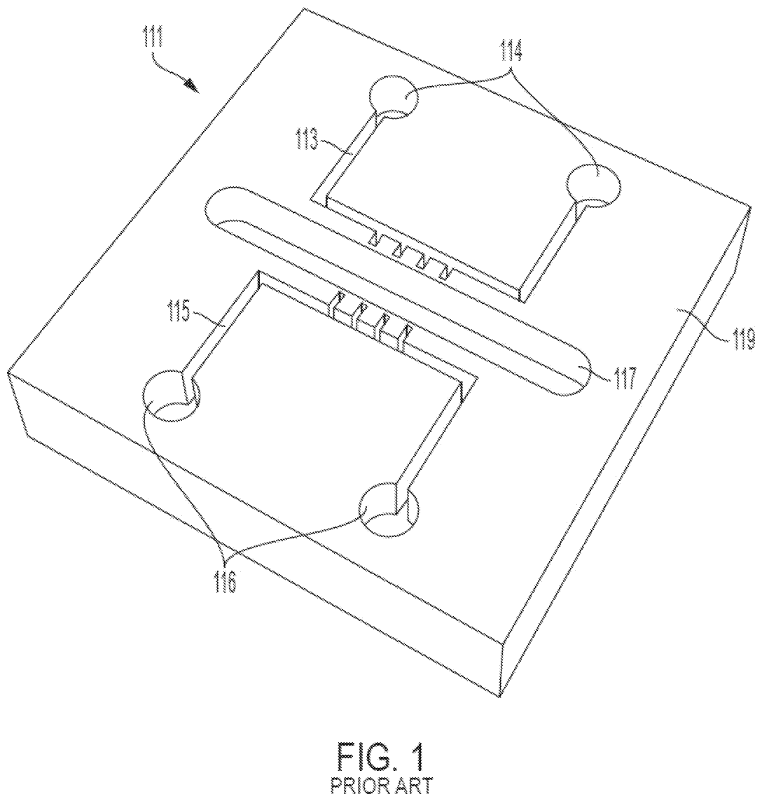

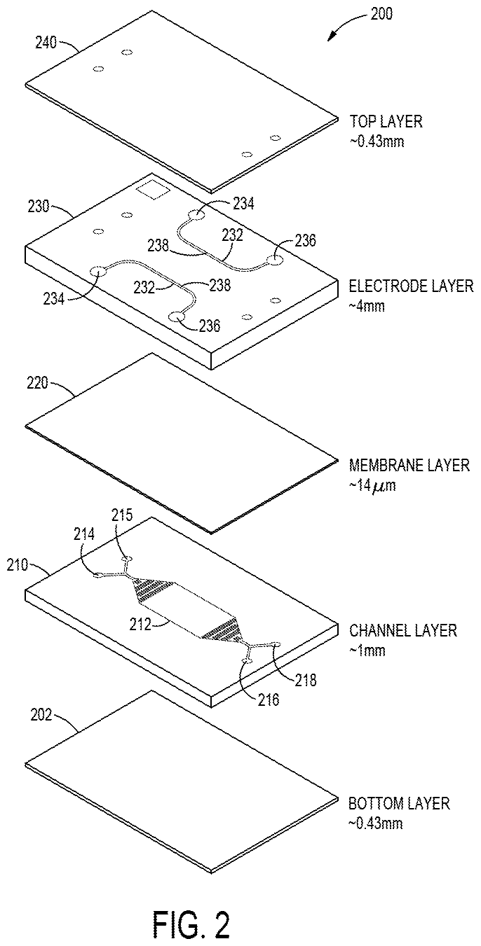

FIG. 2 shows an example microfluidic device 200 in the form of a cDEP device formed in multiple layers, i.e., in which the electrode channels 232 and sample channel(s) 212 are in different layers of the device 200, in accordance with disclosed embodiments. However, it should be noted that the disclosed embodiments and features are equally applicable to single layer devices, in which the electrode channels and sample channel(s) are formed in the same layer are also contemplated, for example as described in the Davalos patents and shown in FIG. 1. Further, while the remainder of this specification will be described with respect to a cDEP microfluidic device 200, this description and embodiments may be utilized with other microfluidic devices in place of cDEP microfluidic device 200, for example, contact DEP devices, multi-array DEP devices, multi-chamber DEP devices, high-throughput DEP devices, fluid exchange devices, cell encapsulation devices, electromanipulation devices, electrokinetic rotation and trapping devices, and point-of-care devices.

Microfluidic device 200 may include a bottom layer 202 made of a material such as polymer, thermoplastic, or glass to seal the sample entry and exit ports (inlet/exit well portion) to the extent such ports extend through the entire thickness of the channel layer 210. The sealed ports allow for pressurized fluidic entry without escape.

Microfluidic device 200 may include a channel layer 210 containing one or more sample channels 212. Microfluidic device 200 may include one or more inlet well portions for receiving samples and other fluids for addition to the sample channel 212. Inlet well portions, may include for example, sample receiving portion 216 and buffer receiving portion 218. A sample containing cells to be separated would, in one example, be added to the sample receiving portion 216. A buffer solution, which assists in carrying the cells across the sample channel 212, would, in one example, be added to the buffer receiving portion 218. The buffer solution may also function, at various points throughout the use of the microfluidic device 200 to maintain cell viability, establish contrasting electric fields, minimize and eject bubbles, wash cells stuck in the channel, flush the system for fluidic pressure balance, and flush the channel between collections to minimize mixing after separation. The fluidic path between the sample receiving portion 216, buffer receiving portion 218 and sample channel may be formed to aide in mixing the sample with the buffer solution. Further, and optionally, the inlets, outlets, and/or the fluidic paths between them and the sample channel can be valved to open and close various ports and channels.

Microfluidic device 200 also includes one or more outlet well portions for removing the separated samples and other fluids from sample channel 212, which would typically be done under pressure of the input buffer and sample solutions. As shown, microfluidic device 200 includes a first outlet portion 214 and a second outlet portion 215, however, any number of outlet portions may be included based on the design of the particular microfluidic device. Depending on the particular process being completed with the microfluidic device 200, one or more outlet portions may be utilized. In addition, a particular outlet portion may be used more than once for sequential collections of different types of cells. And, as noted previously, the inlet and outlets, and/or the fluidic paths between them and the sample channel can be valved to open and close various ports and channels to achieve mixing and/or separation of samples and buffer solutions.

Microfluidic device 200 may include a separate electrode layer 230 containing electrode channels 232 each containing an electrode 238 within the electrode channels 232. The electrode channels 232 and electrodes 238 may be configured to include one or more electrode contact regions 234, 236 at a corresponding well in the electrode channel 232, which are in electrical contact with the electrode 238 that then communicates with an external signal amplifier. When an electrical potential is generated between electrodes 238 an electric field is established across the sample channel 212 having the desired effect on cell separation. The structures in the channel layer 210 and electrode layer 230, including the sample channel 212 and electrode channels 232 may be formed by etching, or by forming the layer materials over a “positive” mold to form the “negative” space of the respective channels or any other means known in the art, for example those methods discussed in the Davalos patents.

The electrode channels 232 need not be straight as shown in FIG. 2, the electrode channels may include bends, notches, saw tooths, curves, or other linear or microscale geometries, for example those shown in FIGS. 1B, 2C, 6A-11C, 13-18B, 28A-42E of U.S. Pat. No. 8,968,542 of the Davalos patents.

The electrodes 238 may be formed of a low melting point, metal or metal alloy electrode. For example, eutectic metal alloys or bismuth metal alloys, including, Field's metal or Field's alloy, which primarily comprises about 32.5% bismuth, about 16% tin, and about 51% indium by weight, and which has a melting temperature of about 62° C., although other variations are also suitable, for example, Cerrolow 136 (comprising about 49% bismuth, about 18% lead, about 12% tin, and about 21% indium by weight), Cerrolow 117 (comprising about 44.7% bismuth, about 22.6% lead, about 8.3% tin, about 19.1% indium, and about 5.3% cadmium by weight), Bi—Pb—Sn—Cd—In—Tl (comprising about 40.3% bismuth, about 22.2% lead, about 10.7% tin, about 17.7% indium, about 8.1% cadmium, and about 1.1% thallium by weight), Wood's metal (comprising about 50% bismuth, about 26.7% lead, and about 13.3% tin) each having a melting point between about 41.5° C. to about 70° C. at a standard atmospheric pressure of 100 kPa. It should be noted that eutectic metal alloys are not required for the disclosed embodiments but may be particularly advantageous based on expected manufacturing and operating conditions. For example, and alternatively, gallium melts at 30° C. and thus would typically melt at normal physiological conditions for biological cells, but may still be used if the intended operating conditions are below 30° C. Further, other single metal or metal alloy may be acceptable, based on the electrode channel geometry and the operating conditions of the microfluidic device provided that the melting point of the metal is below that which would damage of the electrode layer 230 substrate (which would depend on substrate choice material) and that which is above standard operating conditions for the Microfluidic device 200, which is typically between standard room temperature and human physiological body temperature or between about 20-37C. For example, in one example it is advantageous if the melting point of the electrode material is below a temperature that would warp, deform, scorch, and/or soften the material of the electrode layer 230 substrate. In another example, the melting point of the electrode material is between a brittle fracture temperature and a warping temperature of the electrode layer 230 substrate.

The electrodes 238 of the present disclosure have several advantages over traditional liquid electrode solutions, conductive suspensions, gels, epoxys, and even other high melting point metals. First, the disclosed metal electrodes have a higher and more consistent conductivity than prior electrode solutions, which results in a more consistent field application and a device suitable for commercial purposes and repeatable results; second, electrodes 238 formed of a metal alloy as described provide for easy and reproducible connectivity at electrode contact regions 234, 236 to a variety of external electrodes, for example, pins, needles, pogo pins, clamps, metal pads, etc., to connect further to a signal amplifier; third, electrodes 238 formed of a low melting point metal alloy require less cost and energy to liquify or apply and do not damage the electrode layer 230 substrate as compared to plating techniques or other metal-containing epoxys; fourth, because electrodes 238 have a relatively low melting point, the electrode material can be loaded into the electrode channels 232 easily while still filling in small clearance areas in electrode channels 213, 215, allowing for intricate micro electrode structures and for additional design flexibilities; fifth, electrodes 238 formed as disclosed herein have shown resistance to degrading or evaporating under in-use electrical field conditions typically used during electrophoresis applications as compared to prior liquid or epoxy suspensions; sixth, the disclosed metal electrode materials when applied to the electrode channels 232 in liquid form have sufficient density and viscosity to displace air bubbles which would otherwise provide a break in, or diminished electrical conductivity, in the electrodes 238. It should be noted that disclosed electrodes 238 and methods of forming such electrodes 238 further provide such benefits over the use of conductive solutions, suspensions, paints, and epoxys, which have a higher tendency to trap gas bubbles in their solution that result in decreased or inconsistent electric field production when electricity is passed through the electrodes, or, if the bubbles are large enough in size or quantity, will result in a discontinuity and thus the electrodes would produce no electrical connection at all.

As noted previously, in alternative embodiments of the invention, the functions of the channel layer 210 and the electrode layer 230, e.g., the sample channel 212 and the electrode channels 232 may be formed in a single layer such that the sample channel 212 and the electrode channels 232 are formed in the same layer. However, in embodiments in which the channel layer 210 and the electrode layer 230 are separate layers, an interceding membrane layer 220 may be included that, in one example, functions to seal the sample channel 212 but also separate the sample from the electrode channel, to achieve a cDEP process.

Membrane layer 220 may be, for example, bonded to channel layer 210 through the use of thermal bonding, laser welding, adhesive bonding, plasma bonding, or any other bonding known in the art. In one example, as shown, Membrane layer 220 seals the sample channel 212 by plasma bonding to achieve cDEP conditions. Membrane layer 220 may be, for example, any known transparent material that can form a suitable bond with the channel layer 210 and electrode channel layer 230 materials to prevent sample fluids from leaking out of the channel layer 210. Additionally, for example, the membrane layer 220 may also sustain separation between the main channel layer 210 and electrode channel layer 230 to sustain contactless electrical field generation. In one example, the membrane layer 220 includes or is made of an inert of biologically compatible material that is compatible with the buffer and sample while also allowing electrical field gradients to pass. Ideally, there is biocompatibility between the material and the sample, i.e., the material sustains viability over the sample over a long period (longer than time it takes to perform the microfluidic test or separation). However, because the contact time of the sample with the membrane layer 220 may be relatively short during the use of a channel layer 210, the material being inert is sufficient such that it is not harmful or toxic to the sample cells. Non limiting example membrane layer 220 materials include one or more of the following: cyclic olefin copolymer, polydimethylsiloxane (PDMS), polymethyl methacrylate (PMMA). However, others may be used. In other embodiments of the invention, the membrane layer 220 is made from plastic, silicon, glass, polycarbonate, polyimide, such as the polyimide film KAPTON produced by Dow Chemical (Midland Mich.), carbon nanotubes, fused silica, quartz, borosilicate, and/or piezos. Specific, non-limiting examples include silicon oxide, silicon nitride and polyethylene. While a number of applications can benefit from being able to see the sample channel 212, if a particular application does not require a visual inspection of the sample channel 212, then membrane layer 220 may be substituted for a non-transparent material having similar sealing and conducting properties.

Further, another advantage of the disclosed electrodes 238 and electrode layer 230 is that there is no requirement to use a top sealing layer to prevent spillage and exposure of the liquid electrodes because the metal electrodes 238 are not prone to separating from the electrode channels 232 and are less susceptible to damage after solidifying. However, as shown in FIG. 2, a top layer 240 may be included if desired for overall presentation, for example as a labeling layer or to present a more finished commercial product appearance.

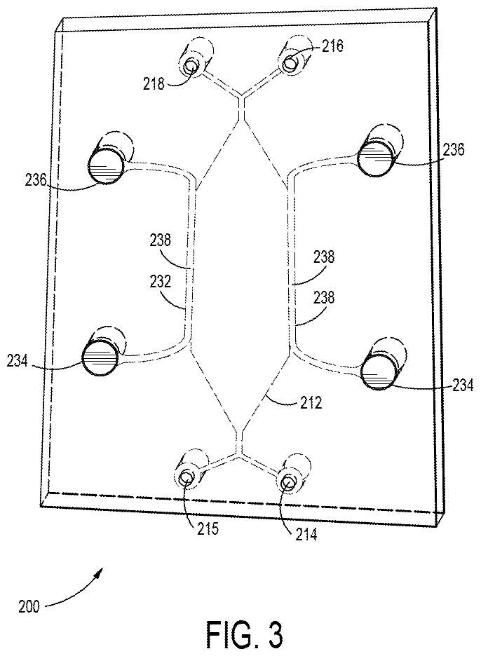

FIG. 3 is a perspective view of an example microfluidic device 200 similar to that of FIG. 2 after application of a sample in the sample channel 212 and the installation and solidification of two electrodes 238 within channels 232 between electrode contact regions 234, 236.

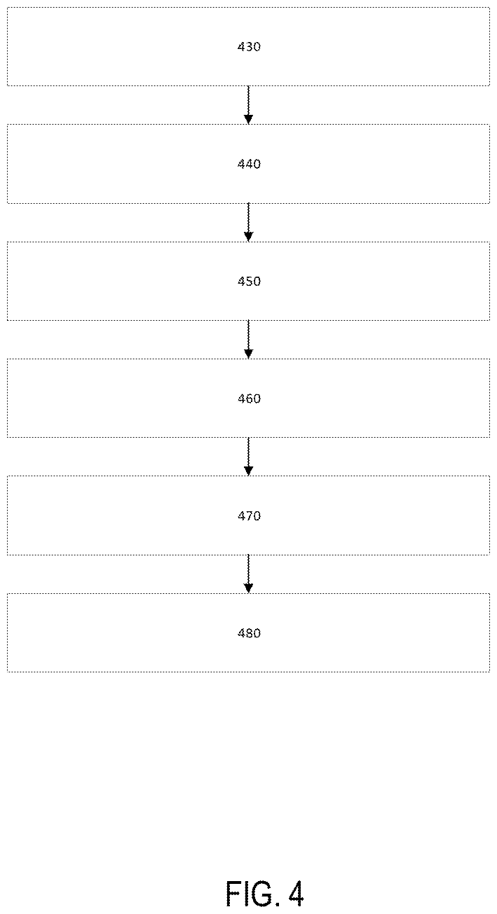

With reference to FIG. 4, an example method is disclosed to form microfluidic devices as described herein, for example the microfluidic device 200, including electrode layer 230. At step 450, the electrode material is heated to or just beyond its melting point, for example, about 62° C. At step 460, the electrode material is injected with steady pressure, which for example, may be between about 0.06 to about 1 pounds per square inch (psi) into the electrode channel 232 from either end of the electrode channel 232, i.e. at an electrode well near electrode contact regions 234, 236. If a top layer 240 is utilized, then the electrode material may be injected through the top layer by piercing the top layer 240 at or near electrode contact regions 234,236. For injecting the electrode material, a syringe or other suitable liquid pump may be utilized. Sufficient pressure should be utilized such that the electrode material flows through the electrode channel 232, however the application pressure should not be so high as to rupture the membrane layer 220. Application pressure, may, in one example, remain about constant after the electrode material begins to flow until the electrode material fills the opposite electrode well at electrode contact regions 234, 236.

Optionally, at step 430, the electrode layer 230 and/or microfluidic device 200 may be warmed, for example, above ambient temperature, prior to step 460 to minimize solidifying of the electrode material until the electrode channel 232 is filled. Similarly, and optionally at step 440, the syringe or other liquid pump may be warmed, for example, above ambient temperature, prior to step 460 to increase the working time of the electrode material and application window.

At step 470, the electrodes 238 may be optionally visually inspected and the electrode(s) 238 are allowed to solidify by cooling at room temperature or by other cooling means, for example forced or natural convection or conduction. In one alternative, a fan may be used to blow air across the electrode layer 230. At step 480, following the cooling step, the electrodes may be tested for electrical continuity between the electrode contact regions 234,236.

1. A microfluidic device comprising:
at least one electrode channel; and
an electrode within the electrode channel, wherein the electrode is metallic and has a melting point below about 70° C.

2. The microfluidic device of claim 1, wherein the at least one electrode channel comprises at least one electrode contact region and the electrode is within the electrode contact region.

3. The microfluidic device of claim 2, wherein the at least one electrode channel and the sample channel are formed in a same layer of the of the microfluidic device.

4. The microfluidic device of claim 2, wherein the at least one electrode channel and the sample channel are formed in different layers of the of the microfluidic device.

5. The microfluidic device of claim 2, wherein the at least one electrode channel comprises at least two electrode contact regions and the electrode channel is exposed to the atmosphere between the at least two electrode contact regions.

6. The microfluidic device of claim 1, wherein the electrode channel includes at least one of a bend, a notch, a saw tooth, and a curve.

7. The microfluidic device of claim 1, wherein the electrode is at least one of a eutectic metal alloy, a bismuth metal alloy. Fields metal, Field's allow, Cerrolow 136, Cerrolow 117, a Bi—Pb—Sn—Cd—In—Tl alloy, and Wood's metal.

8. The microfluidic device of claim 1, wherein the electrode has a melting point between about 41.5° C. to about 70° C.

9. The microfluidic device of claim 1, further comprising a sample channel, wherein the sample channel is fluidically isolated from the one or more electrode channel.

10. The microfluidic device of claim 1, wherein the electrode channel is formed in substrate comprising and the electrode has a melting point below a deformation temperature of the substrate.

11. A method of making a microfluidic device, the method comprising:
providing a metallic electrode material and heating the electrode material at least to its melting point to form a melted electrode material;
adding the melted electrode material to an electrode channel of a microfluidic device; and
cooling the melted electrode material to form an electrode.

12. The method of claim 11, wherein adding the melted electrode material to the electrode channel comprises injecting the melted electrode material.

13. The method of claim 12, wherein adding the melted electrode material to the electrode channel comprises injecting the melted electrode material with about steady pressure.

14. The method of claim 12, wherein injecting the melted electrode comprises injecting the melted electrode with at least one of a syringe and a pump.

15. The method of claim 13, wherein steady pressure is between about 0.06 to about 1 pounds per square inch (psi).

16. The method of claim 13, further comprising warming at least one of a syringe and a pump above ambient temperature.

17. The method of claim 11, further comprising piercing a top layer.

18. The method of claim 11, wherein adding the melted electrode material to the electrode channel comprises filing the electrode channel between a plurality of electrode contact regions.

19. The method of claim 11, further comprising warming the microfluidic device above ambient temperature.

20. The method of claim 11, further comprising cooling the melted electrode material sufficiently to form a solid electrode.
